(19) United States
(12) Patent Application Publication
(10) Pub. No.: US 2025/0153465 A1
(43) Pub. Date: May 15, 2025

(54) GLAZING WITH ENHANCED HEAD-UP DISPLAY PERFORMANCE

(71) Applicant: AGP WORLDWIDE OPERATIONS GMBH, Zug (CH)

(72) Inventors: Alexey KRASNOV, Northville, MI (US); Juan Pablo SUÁREZ, Baesweiler (DE); Stefan GOSSEN, Baesweiler (DE); Débora ROMERO BARCELLOS DE OLIVEIRA, Sao Jose dos Pinhais (BR)

(21) Appl. No.: 18/723,061

(22) PCT Filed: Dec. 22, 2022
(86) PCT No.: PCT/EP2022/087622

§ 371 Date: Jun. 21, 2024

(30) Foreign Application Priority Data
Dec. 22, 2021 (EP) 21217117.7

(51) Int. Cl. B32B 17/10; B60J 1/00; C03C 17/36; G02B 1/113; G02B 27/01

(52) U.S. Cl. CPC B32B 17/10183; B32B 17/10036; B32B 17/10201; B32B 17/10229; B32B 17/10348; B32B 17/10761; C03C 17/3626; C03C 17/3649; C03C 17/3657; C03C 17/3681; G02B 1/113; G02B 27/0101; B32B 2307/584; B32B 2605/00; B60J 1/00; C03C 2217/216; C03C 2217/22; C03C 2217/27; C03C 2217/281; G02B 2027/012

(57) ABSTRACT

Head-up displays, HUD, have been in commercial use for several decades in diverse applications seeking to minimize driver distraction while at the same time dealing with the overload of information available from the various vehicle systems. The disclosure provides an HUD coating glazing that when used in conjunction with a projecting means emitting p-polarization light, results in a bright, high contrast image with substantially no secondary images. The coating of the present disclosure is deposited on at least a portion of the glass surface of the windshield, or any other vehicle glazing, allowing for multiple displays and supporting augmented reality, the coating comprising at least one first dielectric layer being Si-based layer, a functional metallic layer, a second dielectric layer with an index of refraction between 1.4 and 2.0 and at least one third dielectric layer having scratch-resistance and environmentally protective properties.

### FIELD OF THE DISCLOSURE

The disclosure relates to the field of vehicle glazing and, more specifically, to vehicle windshields with Heads-Up Display capability.

### BACKGROUND OF THE DISCLOSURE

Head-Up Display (HUD) is a technology which is used to display information in a manner that allows the driver of the vehicle to view values, normally found in the instrument panel, in the forward field of view. The projected graphic appears as if floating in space in front of the vehicle. This allows the driver to continue to view the road and environment in the forward direction of travel without having to look down at the instrument panel to check speed, RPM, and other values. In other words, with his head up.

The principle of operation is easy to understand. If you have ever placed a map or other light-colored object on the instrument panel of your car, you may have noticed that the reflection made it appear as if the object was floating in front of the windshield. In the same manner a projector is placed in the instrument panel which projects the graphic onto the windshield in the driver field of view as illustrated in FIG. 2A. The image is reflected by the windshield which serves to combine the projected image with the forward view of the driver forming an augmented reflected image superimposed on the real view of the surroundings.

Originally developed for use by aircraft pilots, the first HUD displays began to appear in automobiles in the 1980s. Due to the large bulky projector that had to be packaged in the instrument panel, high price, and limited perceived utility, growth was slow. However, as efforts to reduce driver distraction from the overload of information available to the driver have increased, so has the value of HUD. Further the much smaller size, lower weight, and lower cost of the graphic projector have dramatically improved the feasibility of deployment in more and more vehicles where space inside of the instrument panel is limited. The technology used to produce the projector is the same as used for mobile phone, tablet, laptop, and television displays which has substantially reduced not just the size and weight but also the cost of the projector.

For the 2020 model year, in the USA alone, over three hundred models were available with HUD as standard equipment or as an option.

The discussion of the background and the disclosure is best understood by first referencing FIG. 1 where the terminology to be used is illustrated.

Typical vehicle laminated glazing cross sections are illustrated in FIGS. 1A and 1B. A laminate is comprised of two layers of glass 2, the exterior or outer, 201 and interior or inner, 202 that are permanently bonded together by a plastic bonding layer 4, which is also known as interlayer, plastic interlayer, bonding interlayer, adhesive bonding layer or adhesive bonding interlayer. In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic bonding layer 4. An obscuration 6 may be also applied to the glass. Obscurations are commonly comprised of black enamel frit printed on either the number two 102 or number four surface 104 or on both. The area of the glazing that is not covered by an obscuration is the daylight opening. The laminate may have a coating 18 on one or more of the surfaces. The laminate may also comprise a film 12 laminated between at least two plastic bonding layers 4.

The present disclosure includes but is not limited to laminated glazing or single glass layers. FIG. 1C shows a typical tempered vehicle glazing cross section comprised of a single layer of glass 203 which has been heat strengthened. The glass surface that is on the exterior of the vehicle is referred to as surface one 301 or the number one surface. The opposite face of the exterior glass layer 203 is surface two 302 or the number two surface. The number two surface 302 of a tempered glazing is on the interior of the vehicle. In additional embodiments of the disclosure, an obscuration 6 may be also applied to the glass. Obscurations may be understood as black enamel frit printed on the surface of the glass layers. In the embodiment of FIG. 1C, an obscuration comprised of a black enamel frit is printed on number two 302 surface. The glazing may have functional coating 18 (not shown in FIG. 1C) on the number one 301 and/or number two 302 surfaces, such as infrared reflecting coating, or solar control coating.

In a HUD system, the windshield becomes a critical component in the optical path. However, ordinary windshields, do not provide the image quality that is required. The design and manufacture of windshields that are optimized for HUD brings a number of challenges.

The most obvious challenge comes from the shape and installation angle of the windshield relative to the projector. The best image quality, when projecting an image onto a surface, occurs when the surface is flat, and the image is projected perpendicular to the surface. As a windshield is typically curved and the projector cannot be mounted perpendicular to the windshield, the projected image must be compensated so that the image is undistorted when viewed.

Another challenge is that of secondary images. In FIG. 2A the cross section of a standard windshield with HUD is shown. It comprises an inner glass layer 202, an outer glass layer 201 and a plastic bonding interlayer 4 which serves to permanently bond the two glass layers together. The HUD projector 24, mounted in the instrument panel, projects an image 30 onto surface four 104 of the inner glass layer 202 of the windshield. The light enters the windshield at point one 51. At point one, some of the light is reflected due to the discontinuity of the index of refraction between the air and the glass. This reflected beam 31 is perceived by the viewer 40 as the primary image. The transmitted portion of the beam is bent as it enters the glass. The beam passes through the inner glass 202, the interlayer 4 and the outer glass layer where it strikes the number one surface 101 of the outer glass layer 201 at point two 52. Once again, the air/glass interface causes some of the light to be reflected back. From point two 52, the light travels back through the laminate and exits the glass at point three 53 where the reflected beam 32 is perceived by the viewer as a secondary image. The secondary image formed by the reflected beam 32 will be dimmer than the primary image formed by the reflected beam 31 but under the right cabin and exterior lighting conditions may be visible. The separation distance between the two images will also influence how noticeable the double image may be. If the distance is small and the two images overlap, the secondary image will tend to increase the brightness of the primary image. If the separation distance is too great, the perception will be of a double image which is undesirable.

The plastic interlayer used to laminate all safety glass windshields has a refractive index matched to the index of the glass to prevent internal reflections at the glass-plastic interface. However, if the windshield has a coating on the number two 102 or number three 103 surface, internal reflections will result unless the coating is also matched to the index of refraction of the glass and interlayer, which may be about 1.5. This is typically not the case with the transparent metallic/dielectric solar control coatings 18 depicted in FIG. 2B that are finding increased use as manufacturers seek to increase the fuel efficiency of their vehicles while also improving passenger comfort and convenience. These coatings are tuned to transmit in the visible light range while reflecting in the infrared range.

FIG. 2B illustrates a typical solar coated windshield with a silver-based coating 18 on surface three 103, along with HUD. The beam path of FIG. 2A remains the same. But, at the coating-interlayer interface an additional reflection can be found at point four 54. The light exits the inner glass surface 104 at point five 55 and results in a third or tertiary image formed by the reflected beam 33 in addition to the secondary image formed by the reflected beam 32 and the primary image resulting from the reflected beam 31.

As the double and triple images are only a problem when the separation distance is too great, it has been found that making a small adjustment between the planes of the two glass layers can shift the images so that they converge. Normally the two glass layers are parallel. To create an angle between them a plastic interlayer that is non-uniform in thickness is used. This is known as a “wedge” interlayer.

A HUD system with a wedge interlayer 4 laminate is shown in FIG. 3A. It can be seen that the angle of the reflected beam has been altered so that the secondary image 32 overlays the primary image 31.

There are a number of methods used to produce wedge interlayer. With some, the taper in thickness is at a constant angle across the whole width of the interlayer. Other methods maintain a constant thickness and then begin to taper as they approach the HUD portion of the interlayer. Still other methods have been devised that make use of a variable angle tailored to the specific windshield (WS).

In addition to the wedge interlayer, the use of very thin glass has been used to reduce the separation distance as well as tapered thickness glass. A drawback that all of the wedge solutions share is that they are only effective for a secondary image. If there are more than two reflected images, then the wedge solution can only be optimized for one reflected image. Also, the wedge solution can only be optimized for a portion of the driver field of view due to the curvature of the windshield and varying incident angle.

While wedge interlayer is effective and in common use, it does have drawbacks.

For one, it is much more expensive to produce than standard interlayer. The wedge angle is produced through an extrusion process. This requires a change in the tooling and a transition period during which the product is not within tolerances.

Due to the several different angles, different sunshade tint color and width, roll widths and other dimensions needed, the wedge interlayer is generally produced to order for a specific model windshield in relatively short production runs and not kept in inventory. As a result, it tends to be expensive and can have a long lead-time.

The non-uniform thickness of the wedge interlayer can result in problems passing regulatory requirements as it can get too thin or too thick, especially on larger parts. This is why there are some variants that maintain constant thickness and do not start the taper from the top of the interlayer sheet.

The biggest drawback of wedge interlayer is that the image displacement is only corrected in the vertical direction and only at the center of the drivers' field of view. This is not so much an issue with the current small displays intended primarily for the driver and centered with the drivers' field of view but as the display area increases, and at some point, may encompass the entire windshield, wedge interlayer will not be an option.

Another approach to correct for double image and improve the quality of the graphic image is through the use of a HUD holographic film also known as HUD film. This approach is illustrated in FIG. 3B. Here, the beam follows the same path as shown in FIG. 2A and results in a double image formed by the reflected beams 31 and 32. However, as the HUD film 22 is laminated between two layers of a plastic bonding layer such as Polyvinyl Butyral (PVB) interlayer, the reflected beam 32 exiting the 104 surface at point three 53 is closer to the reflected beam 31 exiting at point one 51, which makes the primary and secondary images form closer together. The higher reflectivity of the HUD film 22 reduces the intensity of the light transmitted past point two 52 and effectively eliminates the tertiary image that would have resulted from the reflection from the number one 101 surface. The reflection is still there but the intensity is much lower which makes it unnoticeable. These HUD films may be laminated between two layers of plastic bonding layer 4 or optically bonded to the number two 102 or number three 103 surface. An HUD film may be used along with a wedge interlayer to further improve optics.

The HUD holographic films have similar drawbacks to the wedge interlayer solution. They are expensive and in addition to the higher material cost of the film and the second layer of interlayer or optical adhesive, there is also additional labor required to assemble the laminate with the film inside. The integration of the film into the WS has problems such as wrinkles in the film, performance degradation due to chemical reaction with the interlayer and diffraction of sunlight. The edges of the film tend to be visible as well. The only means found to overcome this limitation has been to extend the film across the entire WS. This of course increases the cost even further and makes lamination that much more difficult.

In addition to these drawbacks, the HUD holographic films should be implemented with specific holographic film HUD projectors. These projectors have also been developed in the last few years. They have not been widely implemented due to a number of drawbacks. They require an expensive projection system (narrowband laser diodes).

As the size of the HUD viewing area increases, films become less and less viable. Due to their optical and mechanical properties the size of the area where the film can be used is limited. They are not suitable for use in the drivers' direct line of sight due to their optical properties. It may not be possible to laminate some films in windshields with complex curvature due to the inability of the film to conform to the curvature without the formation of defects such as wrinkles.

Another issue with films is maintaining the level of light transmission. The minimum value of total visible light transmission through the windshield must be at least 70% according to regulatory requirements. Normally, to optimize solar performance, a windshield will be designed to have a total visible light transmission that is only a few percent above 70%. If the HUD film reduces light transmission, then the other components of the laminate must be modified to compensate, thus reducing solar performance.

Another challenge is associated with the polarization of the projected light. Particularly, polarized sunglasses, that many drivers wear, transmit only p-polarized light. The reflection of the image projected by a typical HUD projector with primarily s-polarized light is not visible through polarized sunglasses. S-polarization light is used for HUD projectors because ordinary untreated soda-lime glass will reflect up to 10% of the projected s-polarization light allowing the projected to be visible with no special modifications to the glazing or a projection screen.

With a HUD projector that emits primarily p-polarization light the situation is very different. For one, reflected p-polarization light is visible through polarized sunglasses.

As an added benefit, if the p-polarization image is directed at the windshield at an angle of incidence, AOI, equal to the Brewster angle for the glass/air interface, the p-polarized component has a negligible reflectance at both the vehicle interior, surface four 104, and the vehicle exterior, surface one 101, of the windshield with typical, untreated, laminated soda-lime glazing. This eliminates any secondary images. However, most of the light passes through the glazing also eliminating the primary image.

Therefore, the glazing must be modified to reflect the p-polarization light to form a visible image. This is typically done with a p-polarization reflecting film or coating. Any of the light that is not reflected or absorbed passes through the glazing and exits the glazing without being reflected by the vehicle exterior air/glass interface. If the p-polarization reflecting film or coating is laminate inside of the glazing there is no reflection from the interior, surface four, of the glazing. This helps to greatly reduce the intensity of secondary images while increasing the intensity of the primary image.

However, it is virtually impossible to project the entire image precisely at the Brewster angle calculated for the glass/air interface. The image is typically projected at incident angles between 60 and 73 degrees. Any deviation from the Brewster angle results in an increase in the intensity of the p-polarized light component forming the secondary image reflected from the glass/air interfaces. It is important, therefore, to increase the reflectance of p-polarized light forming the primary image so as to attain a sufficiently high contrast between the primary and secondary images.

It is desirable to have the perceived contrast between the primary and each of the secondary images of at least 5:1. It is also desirable to maintain the intensity of the reflected p-polarized light and the light with mixed polarization respectively at least 20% and no more than 30% across the visible wavelengths. At less than 20% of p-polarized reflectance, the image is perceived as washed out and difficult to see under bright lighting conditions and at above 30% of mixed-polarized reflectance, it can become distracting and interfere with vision in low light conditions.

Attempts have been made to meet the above-mentioned requirements using silver-inclusive solar-control coatings sputter-deposited on surface two of a laminated windshield. Document U.S. Pat. No. 10,437,054 B2 demonstrates a reflection of the p-polarized light on surface two R (p-pol)<5%. Although this type of coating allows for some control of p-to-mixed polarization, it is not a good polarizer, and the desired contrast between the primary reflection, from the coating on surface two in this case, and each of the secondary reflections on surface one and surface four, cannot be achieved.

Attempts have also been made to place a silver-inclusive solar-control coating on surface four S4 of the laminate, the surface that is facing the interior of the vehicle, but always requiring the presence of a polymer for protection of the silver-inclusive coating. Silver-inclusive coatings, however, are known for their poor environmental stability when they are not well encapsulated. This is the reason that these coatings are usually laminated between two sheets of glass in vehicle applications and deposited on inner surfaces of architectural integrated glass units (IGUs) filled with inert gas. When placed on a surface exposed to the air, such as surface four of a conventional laminated windshield, a silver-based coating will inevitably suffer from the ingress of moisture vapors through tiny pinholes in the protective coating and/or through the expose edges at the perimeter.

In addition to the environmental issue, windshield must pass rigorous durability tests to comply with government safety regulations. For instance, windshields with silver-inclusive coatings on surface four can have problems to passing the standard Taber abrasion test, as specified by FMVSS 205 (Federal Motor Vehicle Safety Standard).

Another method has been to use an anti-glare coating on surface four, such as that disclosed by document U.S. Pat. No. 6,137,630 A. However, this only partially mitigates the problem, i.e., by reducing the contribution of the secondary reflection from surface four. However, the secondary image from surface one still exists.

There are several examples in the prior art that suggest the use of an all-dielectric multi-layer coating with a significant reflectance of p-polarized light comprising alternating layers with high and low indices of refraction (H-L-H-L) on surface four. The advantage of placing the primary p-pol reflecting layer on surface four is to eliminate one of the two secondary reflections. However, simulations show that the disclosed coatings only approach a 5% level of p-polarized reflectance, which is insufficient to achieve high the 5:1 contrast between the primary p-polarized reflection and mixed-polarized secondary reflection.

As the field of view becomes larger and HUD displays become more common, it would be highly desirable to be able to eliminate secondary images while also improving the quality of the perceived image and to be able to project to any portion of the glazing.

### BRIEF SUMMARY OF THE DISCLOSURE

The present disclosure provides a solution to the aforementioned problems by means of a vehicle glazing according to claim 1, a HUD system according to claim 12, and a vehicle according to claim 14.

The disclosure comprises a coated glazing wherein the coating is optimized to produce a sharp, high contrast, HUD image when used with a projector that emits p-polarized light. The glazing is coated with a thin-film layer stack having a high p-polarized reflectance and deposited on the surface of the glazing facing the interior of the vehicle as illustrated in FIG. 4.

In a schematic cross-sectional view as illustrated in FIG. 6 the stack, starting from the glass surface on which it is deposited, comprises:
a first dielectric layer;
a functional metallic layer;
a second dielectric layer;
a third dielectric layer comprising at least one scratch resistant dielectric layer.

In a first inventive aspect, the disclosure provides a vehicle glazing comprising:
at least one glass layer (202, 203) having a surface (104, 302) to be positioned facing and adjacent to the interior of a vehicle; and
a transparent HUD coating (28) deposited on at least a portion of said surface;
   wherein said HUD coating (28) comprises starting from the glass surface:
   at least one first dielectric layer, such first layer being a Si-based layer;
   a functional metallic layer comprising at least one metallic sublayer, each formed by one or more metal elements from the group consisting of metal, alloy or combination of metal and alloy, wherein the total content of said one or more metal elements within each sublayer is at least 5 wt. % and wherein the concentration of oxygen or nitrogen in each metallic sublayer is less than or equal to 10%;
   at least one second dielectric layer with an index of refraction between 1.4 and 2.0; and
   at least one third dielectric layer having scratch resistance properties.

In specific embodiments, the metal, alloy or combination of metal and alloy comprises Al, Ti, Ni, Cr, Pd, Pt, Cu, Co and Au.

When used with a HUD projector that emits substantially p-polarization light, the HUD coating may advantageously provide at least a 5:1 contrast ratio between the primary reflection and the secondary p-polarized reflection of light. The intensity of the reflected p-polarized light may be at least 20% across the visible wavelengths ranging from 490 nm to 700 nm. The reflected light, with mixed polarization including p-polarization, may be no greater than 30% across the visible wavelengths ranging from 490 nm to 700 nm, respectively, as shown in FIG. 5B (solid line).

When used with a HUD projector that emits mixed polarization light, the coating may provide advantageously at least a 4:1 contrast ratio between the primary reflection and the secondary p-polarized reflection of light. The intensity of the reflected p-polarized light may be at least 15% across the visible wavelengths ranging from 490 nm to 700 nm. The reflected light, with mixed polarization including p-polarization, may be no greater than 40% across the visible wavelengths ranging from 490 nm to 700 nm, respectively, as shown in FIG. 5B (dashed line).

The coating has a minimal effect upon total visible light transmission and may be regarded as transparent, in other words, a material that allows the visible light to pass through it completely or almost completely. For instance, the coating may have a total visible light transmission of at least 80%, 85%, 90%, 95%, 96%, 97%, 98% or 99%. Windshields or other vehicle glazings can be made with the HUD coating that have a total visible light transmission of at least 70%.

The coating is durable and capable of passing all regulatory requirements. The coating can be applied to a limited area or over the entire surface of the glazing, for instance, a windshield. The HUD display area of the glazing can be expanded from the typical small area directly in front of the driver to essentially the entire glazing. Multiple projectors can be used, including projectors with a wide field of view.

In a second inventive aspect, the disclosure defines a HUD system comprising a vehicle glazing according to any of the embodiments of the first inventive aspect and further comprising a HUD projector that projects a p-polarized image onto said at least a portion of the glass surface coated with the HUD coating.

In another inventive aspect, the disclosure defines a vehicle comprising a glazing according to any of the embodiments of the first inventive aspect or a HUD system according to any of the embodiments of the second inventive aspect.

### Advantages of the Present Disclosure Include

Double image eliminated.
Less sensitive to viewing angle and the AOI.
Suitable for the entire surface of the glazing.
Eliminates the need for a wedge interlayer.
Eliminates the need for a HUD holographic film.
Lower cost compared to using wedge or HUD holographic films.
Image can be viewed with polarized eyewear.
Enables augmented reality.
Enables use of multiple projectors.
Enables use of projectors with a wide field of view.
Simplicity of making.
Better control of color.
Bi-polarized congruent in green, blue, red wavelengths.
Environmentally stable.
Better control of the coating in surfaces facing the environment (surface four) which is exposed to the air.

All the features described in this specification (including the claims, description and drawings) can be combined in any combination, with the exception of combinations of such mutually exclusive features.

### BRIEF DESCRIPTION OF THE DRAWINGS

To better understand the disclosure, its objects and advantages, the following figures are attached to the specification in which the following is depicted:

FIG. 1A illustrates the cross section of a typical laminated vehicle glazing (Prior Art).

FIG. 1B shows the cross section of a typical laminated vehicle glazing with performance film and coating (Prior Art).

FIG. 1C shows the cross section of a typical tempered monolithic vehicle glazing (Prior Art).

FIG. 2A shows the cross section of a standard windshield with HUD (Prior Art).

FIG. 2B shows the cross section of a typical solar coated windshield with HUD (Prior Art).

FIG. 3A illustrates the cross section of a HUD windshield with a wedge interlayer (Prior Art).

FIG. 3B shows the cross section of a HUD windshield configured with HUD holographic film (Prior Art).

FIG. 4 shows the cross section of a windshield, with the HUD coating of this disclosure, and a substantially p-polarization projector (a HUD projector emitting light with mixed polarization might be used as well).

FIG. 5A shows an example of the spectral distribution of the Contrast Ratio between the primary (surface 4) and secondary (surface 1) reflection for projected light with 100% p-polarization and various angles of incidence over a HUD coating comprising (starting from the glass surface): a SiNx layer, a Al layer, a SiOxNy layer, and an encapsulating SiOx layer.

FIG. 5B shows an example of the p-polarized and mixed-polarization reflectance fraction, the ratio between the incident and the reflected light of the same HUD coating from FIG. 5A.

FIG. 6 shows a schematic cross-sectional view of an embodiment of the HUD coating of the present disclosure.

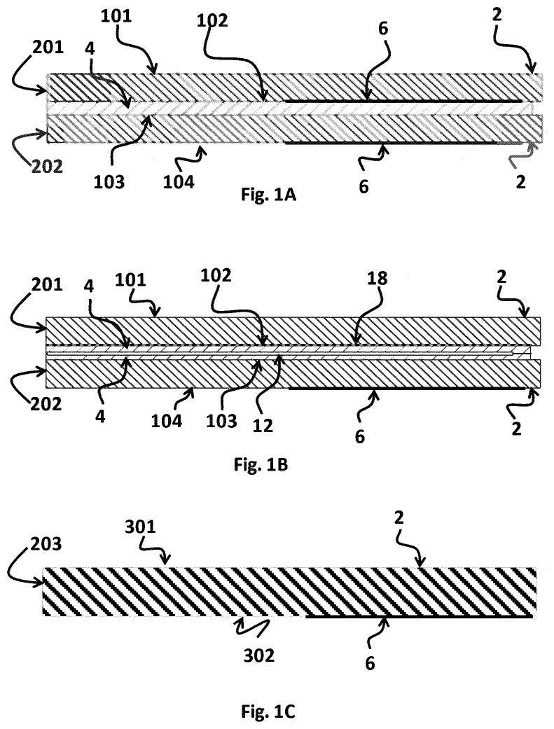

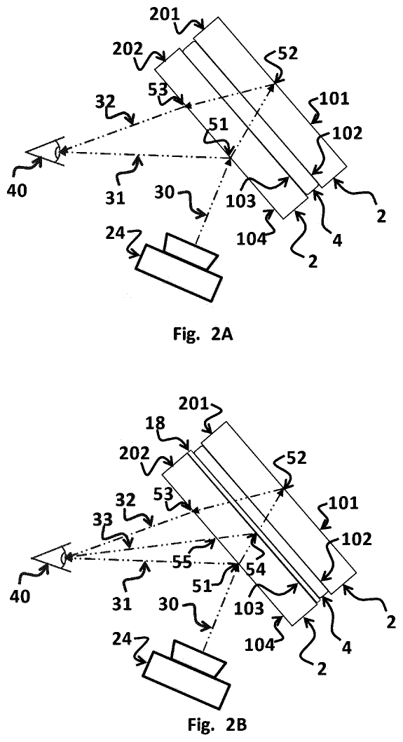

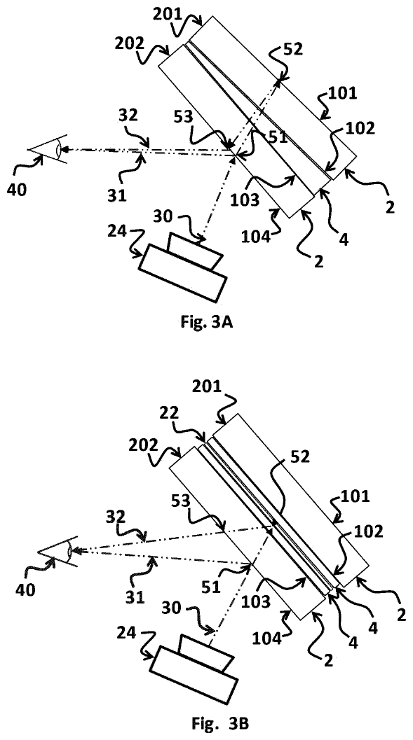

### REFERENCE NUMERALS OF DRAWINGS

2 Glass.
4 Bonding/Adhesive layer (plastic Interlayer).
6 Obscuration/Black Paint.
12 Infrared reflecting film.
18 Infrared reflecting coating, solar-control coating.
22 HUD holographic Film.
24 HUD Projector with mixed polarized light.
26 HUD Projector with substantially p-polarized light.
28 HUD Coating.
30 Projected Image.
31 Primary Image.
32 Secondary Image.
33 Tertiary Image.
40 Eye point.
51 Point 1.
52 Point 2.
53 Point 3.
54 Point 4.
55 Point 5.
101 Exterior side of glass layer 201, number one surface.
102 Interior side of glass layer 201, number two surface.
103 Exterior side of glass layer 202, number three surface.
104 Interior side of glass layer 202, number four surface.
30 Exterior side of glass layer 203, number one surface.
302 Interior side of glass layer 203, number two surface.
201 Outer glass layer.
202 Inner glass layer.
203 Glass layer for monolithic glazing.

### DETAILED DESCRIPTION OF THE DISCLOSURE

The present disclosure can be understood by reference to the detailed descriptions, drawings, examples, and claims, of this disclosure. However, it is to be understood that this disclosure is not limited to the specific compositions, articles, devices, and methods disclosed unless otherwise specified, as such can, of course, vary. It is also to be understood that the terminology used herein is for the purpose of describing aspects only and is not intended to be limiting.

The following terminology is used to describe the glazing of the disclosure.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure. The glazing of the present disclosure is primarily intended for vehicles and more particularly for automobiles (automotive glazing) such as cars.

The glazing of the disclosure may comprise a single or multiple glass layers (201, 202, 203). To comply with regulatory requirements, single glass layer glazing must be tempered, and multiple layer glazing must be laminated.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

The glass layers of a laminate may be annealed or strengthened. Annealed glass is glass that has been slowly cooled from the bending temperature down through the glass transition range. This process relieves any stress left in the glass from the bending process.

There are two processes that can be used to increase the strength of glass. They are thermal strengthening, in which the hot glass is rapidly cooled (quenched) and chemical tempering which achieves the same effect through an ion exchange chemical treatment.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass including those that are not transparent.

The thickness of the glass layers may be for instance between 0.3 mm and 5.0 mm, such as between 0.5 mm and 4.0 mm or between 1.0 mm and 3.0 mm, e.g. about 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm or 3.0 mm. More particularly, the glass layer may be an about 2.1 mm thick ultra-clear soda-lime glass layer. For other uses under the present disclosure, a dark grey soda-lime solar composition with 20% visible light transmission may be suitable.

The glass layers may be comprised of heat absorbing glass compositions as well as infrared reflecting and other types of coatings.

A wide range of coatings, used to enhance the performance and properties of glass, are available and in common use. These include but are not limited to anti-reflective, hydrophobic, hydrophilic, self-healing, self-cleaning, anti-bacterial, anti-scratch, anti-graffiti, anti-fingerprint, and anti-glare. Any of these coatings may be combined with and applied to the glazing of the disclosure.

Methods of application include Magnetron Sputtered Vacuum Deposition (MSVD) as well as others known in the art that are applied via pyrolytic, spray, controlled vapor deposition (CVD), dip, sol-gel, and other methods. The HUD coating of the disclosure may be conveniently applied by means of the MSVD process in the disclosed embodiments.

Silver inclusive coating, as discussed will corrode when exposed to moisture. Methods have been developed to produce coating glass on which the coating does not cover the entire surface. This includes means that are used prior to coating and after. Prior to coating, area where the coating is not desired can be covered by a mask which prevents deposition or a coating which can be removed along with the coating. After coating, the coating may be removed by means of a LASER or through the use of an abrasive process. These same methods may be used to selectively apply the HUD coating of the disclosure to a limited area of the glazing.

The list of coating layers is called the coating stack. When describing a coating stack, we shall use the convention of numbering the coating layers in the order that they are deposited upon the substrate. Also, when discussing two layers, the one closest to the substrate shall be described as below the second layer. Likewise, the top layer is the very last layer applied and the bottom layer is the very first layer deposited upon the substrate. The top of an individual layer is the side of the layer furthest from the substrate while the bottom is closest to the substrate.

The plastic bonding layer 4 (interlayer) has the primary function of bonding the major faces of adjacent layers to each other. The material selected is typically a clear thermoset plastic such as PVB. In addition to polyvinyl butyral, ionoplast polymers, ethylene vinyl acetate (EVA), cast in place (CIP) liquid resin and thermoplastic polyurethane (TPU) can also be used. The thickness of the plastic bonding layer may be for instance between 0.3 mm and 2.0 mm, such as between 0.5 mm and 1.0 mm, e.g. about 0.5 mm, 0.6 mm, 0.7 mm, 0.8 mm, 0.9 mm or 1.0 mm. Standard thicknesses for the plastic bonding layer, e.g. a PVB interlayer, are for instance 0.38 mm and 0.76 mm. More particularly, the plastic bonding layer may be an about 0.76 mm thick PVB interlayer.

The coated glazing of the disclosure takes advantage of and is based upon of the optical properties of light. Light is comprised of perpendicular coupled oscillating electric and magnetic fields. Polarization describes the relative orientation of the fields to a reference. Sunlight is thought of as having random polarization. In fact, it is comprised of an equal mix of various polarizations. This is considered as unpolarized light.

The angle of incident is the angle between the propagation direction and the normal of the surface. The polarization of light is inherent and independent of the incident angle. If the optical field is oscillating in a plane parallel to the propagation plane, then the light is p-polarized. If the field oscillates in a plane perpendicular to the propagation plane, then it is s-polarized.

An interesting phenomenon is that p-polarized light is not reflected when the angle of incidence is at or near the Brewster angle. The Brewster's angle is an AOI at which light with a particular polarization is perfectly transmitted through a transparent dielectric surface, with no reflection. In this case, for an interface between a conventional soda-lime glass and air, the Brewster angle where reflection for p-polarized light is zero, is in the vicinity of 55-60°. However, it is technically challenging to arrange a HUD projector in the instrument panel in such a way as to deliver the light at an AOI matching such a shallow angle to the normal to the glass. Angles of incidence between 60 and 73 degrees are more practical. At these angles, the intensity of the secondary reflected p-polarized image from surface one becomes appreciable.

The HUD projectors have commonly been used to project primarily s-polarized or mix-polarized light. Besides the secondary image, another problem with s-polarized systems is that polarized sunglasses only allow p-polarized light to transmit. Therefore, the HUD image would not be highly visible to a driver with such eyewear.

If a HUD projector that emits primarily p-polarization light is mounted so that the beam projected at an angle of incidence that is at or near the Brewster angle relative to the glazing, the reflections at the glass/air interfaces are substantially reduced or eliminated.

The benefits of the glazing of the disclosure are fully realized with a HUD projector that emits at least 90% p-polarized light. However, substantial improvement in image quality can result, as compared to the methods of the prior art, when used with projectors that emit less than 90% p-polarized light.

As used herein, a HUD projector that emits substantially p-polarization light (26) is intended to refer to emitting at least 90% p-polarized light with respect to the sum of s- and p-polarized light whereas a mixed polarization HUD projector (24) is intended to refer to emitting p-polarized light in an amount of less than 90% with respect to the sum of s- and p-polarized light.

We note that the layers of the coating may have more than one function. The selection of materials used, the sequence of the layers and the layer thicknesses have been carefully selected to optimize for: maximum reflection of p-polarized light, maximum transmission of visible light, neutral color, tolerance to post-deposition heat treatment (e.g., bending of the coated glass) and durability.

The HUD coating stack (28), starting from the glass surface on which the coating is deposited is at first place comprised of at least one Si-based dielectric layer forming a first dielectric layer, such as SiNx or SiOxNy.

The thickness of the Si-based dielectric layer forming the first dielectric layer may be for instance between 30 nm and 80 nm such as between 40 nm and 70 nm or between 50 nm and 60 nm, e.g. about 50 nm, 51 nm, 52 nm, 53 nm, 54 nm, 55 nm, 56 nm, 57 nm, 58 nm, 59 nm or 60 nm. More particularly, the first dielectric layer may be an about 54.3 nm thick SiNx layer.

As used herein, the term deposition can refer to the process of applying the HUD coating of the present disclosure on the glass layer by using commonly known techniques such as MSVD, CVD, etc. The term deposition may also refer to placing the HUD coating onto the glass surface without the need of an additional layer such as a polymer film.

The HUD coating stack also comprises a functional metallic layer comprising at least one metallic sublayer formed by one or more metal elements from the group consisting of metal, alloy or combination of metal and alloy. In additional embodiments, the metal elements comprise at least one or more metals from the following list: Aluminum (Al), Titanium (Ti), Nickel (Ni), Chromium (Cr), Palladium (Pd), Platinum (Pt), Copper (Cu), Cobalt (Co), Gold (Au).

In additional embodiments, the functional metallic layer does not include Silver (Ag) based materials due to the poor environmental stability of Silver, its prone to corrosion when exposed to environmental factors such as moisture and oxygen.

In some particular embodiments of the present disclosure, the functional metallic layer may include Silver (Ag) and/or Silver alloys accompanied with anti-corrosion dopants. The use of Silver with dopants may confer some properties of the Silver, making them usable in the functional metallic layer of the present disclosure.

The content of said at least one metal element within each metallic sublayer is at least 5 wt. % (e.g. at least about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or 100 wt. %) and wherein the concentration of oxygen or nitrogen in each of said at least one metallic sublayer is no greater than 10% (e.g. less than or equal to about 10 wt. %, 9 wt. %, 8 wt. %, 7 wt. %, 6 wt. %, 5 wt. %, 4 wt. %, 3 wt. %, 2 wt. %, 1 wt. % or 0 wt. %).

For instance, the functional metallic layer may comprise 1-5 metallic sublayers such as 1 or 2 metallic sublayers.

The content of said at least one metal element within each metallic sublayer may be 100 wt. % and the concentration of oxygen or nitrogen may be 0 wt. % in certain embodiments.

The metallic elements, Al, Ti, Ni, Cr, Pd, Pt, Cu, Co and Au all have good natural resistance to oxidation. Al, for instance, forms a self-protective Al₂O₃ layer when exposed to oxygen, therefore, being self-insulating if, as an example, is exposed at the unprotected edges of the coating.

Thus, at least one metallic sublayer of the HUD coating may be an alloy of one or more of the elements selected from the group consisting of AI, Ti, Ni, Cr, Pd, Pt, Cu, Co and Au with any other element, wherein the content of said one or more of the elements (Al, Ti, Ni, Cr, Pd, Pt, Cu, Co and Au) is at least 5 wt. % (e.g. at least about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or 100 wt. %), more particularly at least 10 wt. %. For instance, the HUD coating may comprise at least one metallic sublayer of an alloy as previously defined wherein the content of said one or more elements is 100 wt. % in total.

The thickness of the combined metallic functional layer may be for instance between 1 nm and 30 nm and preferably between 1 nm and 15 nm, e.g. about 1 nm, 2 nm, 3 nm, 4 nm, 5 nm, 6 nm, 7 nm, 8 nm, 9 nm, 10 nm, 11 nm, 12 nm, 13 nm, 14 nm or 15 nm. More particularly, the metallic functional layer may consist of or comprise i) an about 4.1 nm thick Al layer, ii) an about 1.1 nm thick NiCr layer and an about 2.9 nm thick Al layer (wherein the percentage of Ni in the NiCr alloy may be about 55 wt. %), iii) CrSi (wherein the percentage of Cr in the alloy may be 95 wt. %), iv) NiCrOx (wherein the percentage of Ni may be about 55% and the content of oxygen may be about 10%), v) AlAg (wherein the percentage of Al in the alloy may be about 5 wt. %), vi) PtAg (wherein the percentage of Al in the alloy may be about 5 wt. %), or vii) an about 4.5 nm thick NiCr (wherein the percentage of Ni in the alloy may be about 55 wt. %).

The HUD coating stack also comprises at least one second dielectric layer with an index of refraction between 1.4 and 2.0, which in preferred embodiments may be comprised of ZnSnOx or SiOxNy. The thickness of the second dielectric layer may be for instance between 10 nm and 100 nm, such as between 20 nm and 75 nm, or between 40 nm and 50 nm, e.g. about 40 nm, 41 nm, 42 nm, 43 nm, 44 nm, 45 nm, 46 nm, 47 nm, 48 nm, 49 nm or 50 nm. More particularly, the second dielectric layer is an about 43 nm thick SiOxNy.

The intended primary location of the HUD coating is on the innermost surface of the glazing such as on surface four (104) in the case of a laminate or on the surface two (302) in the case of a single glass layer glazing (monolithic), where it gets exposed to possible damaging effect of mechanical interaction, e.g., wiping the windshield from the interior side and/or intentional or unintentional contact with objects left on the dashboard (sunglasses, carton boxes with cleaning tissue, suction cups of GPS devices, etc.). This may cause mechanical damage to the exposed coating. Therefore, protection with a scratch-resistant coating becomes important. Moreover, the scratch resistance property also protects the HUD coating from mechanical damages during manufacturing steps such as handling, mechanical cutting/scribing, grinding, etc.

Therefore, the HUD coating stack comprises an outermost dielectric layer, named third dielectric layer with scratch resistance properties. The third dielectric layer comprises one or more layers selected for instance from the group of ZrZnOx, ZrTiOx, ZrTiOxNy, TiOxNy, SiOx, ZrSiOx, ZrOx, and diamond-like carbon, or more particularly selected from SiOx, ZrSiOx, ZrOx, and diamond-like carbon. The thickness of the third dielectric layer may be for instance at least 10 nm, such as between at least 10 nm and 200 nm, or between 20 nm and 175 nm, or between 20 nm and 150 nm, or between 20 nm and 125 nm, or between 20 nm and 100 nm, or between 20 nm and 75 nm, or between 35 nm and 45 nm, e.g. about 35 nm, 36 nm, 37 nm, 38 nm, 39 nm, 40 nm, 41 nm, 42 nm, 43 nm, 44 nm or 45 nm. More particularly, the third dielectric layer may be an about 39.5 nm thick SiOx layer.

The scratch-resistance layer may also serve as an encapsulating material providing a protective barrier that helps to preserve the integrity and performance of the HUD coating. The scratch-resistance layer may help preventing the coating from being damaged by environmental factors, such as moisture, oxygen, which can cause corrosion or degradation. The scratch-resistant layer improves the durability of the surface of the glass, as well as preserving its optical clarity.

The scratch-resistant layer is typically deposited using known processes such as MSVD, CVD, sol-gel, chemical deposition PECVD, or ALD, among others. The thickness of the coating is generally at least 10 nm or greater. These thicknesses have been found to be effective at providing the necessary protection and performance for the HUD coating.

In a preferred embodiment, the scratch-resistant layer of the present disclosure advantageously meets the tests set forth in ISO 9211-4, third edition dated 15 Aug. 2012, which is specifically designed to test automotive requirements, in particular those tests related to withstanding the rigors of abrasion (abrasion resistance tests (conditioning method 01: abrasion)). The scratch-resistant layer has been formulated to provide the necessary protection and performance for the glass surface, helping to maintain its integrity and preserve its optical clarity under conditions of the automotive industry. These properties make the scratch-resistant layer of the present disclosure particularly well-suited for use in automotive applications where protection against scratching and other forms of wear and tear is important.

The second and third dielectric layers of the HUD coating may have for instance a combined thickness of at least 10 nm, such as between 10 nm and 220 nm or between nm and 200 nm or between 10 nm and 180 nm or between 10 nm and 160 nm or between 10 nm and 140 nm or between 10 nm and 120 nm such as between 20 nm and 115 nm, between 30 nm and 115 nm, between 40 nm and 110 nm, between 50 nm and 105 nm, between 60 nm and 100 nm, between 70 nm and 90 nm or between 80 nm and 85 nm. More particularly, the combined thickness of the second and third dielectric layers may be about 82.5 nm.

In the glazing of the disclosure, the functional metallic layer of the HUD coating (28) may have a thickness between 1 and 30 nm, more particularly between 1 and 15 nm; and/or the second and third dielectric layers of the HUD coating (28) may have a combined thickness of at least 10 nm such as between 10 nm and 220 nm.

In certain embodiments, the glazing of the disclosure meets at least one of the following conditions (i) to (iii):
(i) the first dielectric layer of the HUD coating (28) is SiNx or SiOxNy;
(ii) the second dielectric of the HUD coating (28) is ZnSnOx or SiOxNy; and/or
(iii) the third dielectric layer of the HUD coating (28) is selected from the group consisting of: ZrZnOx, ZrTiOx, ZrTiOxNy, TiOxNy, SiOx, ZrSiOx, ZrOx, and diamond-like carbon.

The vehicle glazing of the disclosure may be applied in conjunction with p-polarization HUD projectors, either emitting substantially p-polarization light or mixed polarization light. The disclosure provides a vehicle glazing wherein when an image (30) is projected by a p-polarization HUD projector (24, 26), onto said at least a portion of the glass surface with the HUD coating (28), at an angle of incidence relative to the glass surface of between 60 and 73 degrees, an image comprising a primary and a secondary image is reflected which may have an optical characterization of:
a p-polarization reflection of at least 15% between 490 and 700 nm;
a contrast ratio between the primary and secondary image of at least 4:1; and
a mixed-polarization reflection between 490 and 700 nm of less than or equal to 40%.

In conjunction with HUD projectors that emit substantially p-polarization light, the HUD coating of the disclosure may provide a high level of contrast between the primary reflection and a secondary reflection which is at least 5:1, much greater than that in most cases and an intensity of the reflected p-polarized light of at least 20% and that of the reflected light with mixed polarization of no greater than 30% across the visible wavelengths, respectively. The total visible light transmission of the windshield laminate with the coating in the driver view area preferably is at least 70%.

The disclosure provides a vehicle glazing wherein when an image (30) is projected by a substantially p-polarization HUD projector (26), onto said at least a portion of the glass surface with the HUD coating (28), at an angle of incidence relative to the glass surface of between 60 and 73 degrees, an image comprising a primary and a secondary image is reflected which may have an optical characterization of:
a p-polarization reflection of at least 20% between 490 and 700 nm;
a contrast ratio between the primary and secondary image of at least 5:1; and
a mixed-polarization reflection between 490 and 700 nm of less than or equal to 30%.

Although it is not the primary purpose of such a coating, it may also provide benefits of reducing total solar transmittance (from 300 to 2500 nm) through the assembly.

The disclosed HUD coating can serve its purpose in both the driver field of view (the primary viewing area within the windshield) and the black-paint area (the obscuration area at the bottom of the windshield). For instance, the vehicle glazing may comprise an obscuration (6); wherein the HUD coating (28) overlaps at least partially the obscuration (6) of the glazing and the projected image (30) is at least partially projected onto said obscuration (6).

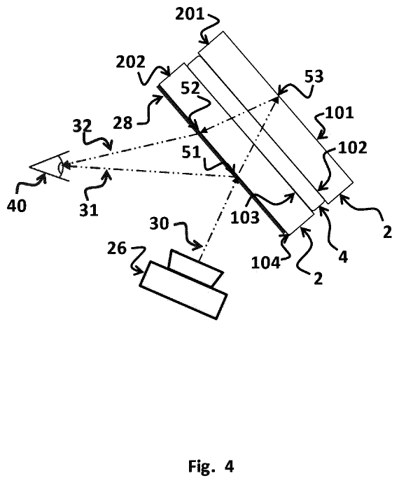

A HUD system with the vehicle glazing of the disclosure is illustrated in FIG. 4. The substantially p-polarization projector 26 is preferentially mounted such that the beam 30 containing the image is projected at an angle of incidence that is within −5/+20 degrees of the Brewster angle. The beam 30 strikes the coating of the disclosure 28 at point one 51. Between 20 and 30% of the light is typically reflected back to the driver 40 along path 31. The light enters the glazing and bends at point one 51, passing through and exiting at point three 53 where some of the light is reflected back and exits the glazing at point two 52 forming the secondary image. Due to the reflectivity of the coating, the high percentage of p-polarized light at or near the Brewster angle, the secondary image formed at point two 52 is substantially less intense than that of the primary image formed at point one 51.

The vehicle glazing of the disclosure may be selected for instance from the group consisting of a windshield, a backlite, or a sidelite.

In certain embodiments, the glazing is a vehicle windshield. While the image is normally projected in the driver field of view in the transparent portion of the windshield, the high contrast of the disclosure allows for information to be projected onto and clearly displayed in the portion of the glazing that has a black obscuration. Most of the fixed glazing parts have a black obscuration applied around the perimeter of the glazing to hide the adhesive. This enables replacing at least some of the displays normally found in the instrument panel, with their projection located closer to the driver's forward view. As the industry moves closer to full autonomous driving, moving the traditional instrument panel display to a location more readily viewed from other seating positions becomes more important. There may not be anyone in the drivers' seat. For instance, the HUD coating (28) may be deposited on substantially the entire surface (104, 302) of the glass layer.

The HUD coating may be used with other types of coatings that are commonly applied to glazing such as solar control coatings. To prevent secondary images due to the solar control coating, the solar control coating may be applied to just the portions of the windshield where the solar coating will not overlap the HUD coating. Alternately, the solar coating may be applied to the entire area and then subsequently removed. For instance, the vehicle glazing of the disclosure may comprise a solar-control coating (18), wherein the glazing is a laminate having at least two glass layers (201, 202), wherein the solar-control coating is deposited on a surface of said at least two glass layers facing the interior of the laminate, and wherein said solar-control coating (18) is not present in the area defined by the HUD coating (28), such that the two coatings do not substantially overlap.

The disclosure also provides a HUD system comprising the vehicle glazing as previously defined and further comprising a HUD projector (24, 26) that projects a p-polarized image (30) onto at least a portion of the glass surface coated with the HUD coating (28). Preferably, the angle between the projected image (30) of said HUD projector (24, 26) and the vehicle glazing is substantially at the Brewster angle of a glass/air interface within ±20%.

The disclosure also provides a vehicle windshield, backlite (backlight) or sidelite (sidelight) comprising the vehicle glazing as previously defined.

The disclosure also provides a vehicle comprising the glazing or the HUD system as previously defined.

The term vehicle in the present disclosure includes, but is not limited to, road vehicles (e.g. cars, busses, trucks, agricultural and construction vehicles, motorbikes), railway vehicles (e.g. locomotives, coaches), aircraft (e.g. airplanes, helicopters), boats, ships and the like. For instance, the vehicle may be a road vehicle and more particularly a car.

The skilled person knows that numerical values relating to measurements are subject to measurement errors which place limits on their accuracy. Where terms such as “about” or “approximately” are applied to a particular value (e.g. “about 200° C.” or “approximately 200° C.”) or to a range (e.g. “about x to approximately y”), the value or range is interpreted as being as accurate as the method used to measure it. Unless explicitly stated otherwise, the general convention in the scientific and technical literature may be applied so that the last digit of numerical values preferably indicates the precision of measurement. Thus, unless other error margins are given, the maximum margin is preferably ascertained by applying the rounding-off convention to the last decimal place. For instance, a value of 3.5 preferably has an error margin of 3.45 to 3.54 and a range of 2% to 10% preferably covers a range of 1.5% to 10.4%. Said variations of a specified value are understood by the skilled person and are within the context of the present disclosure. Further, to provide a more concise description, some of the quantitative expressions given herein are not qualified with the term “about”. It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1% to about 5%” should be interpreted to include not only the explicitly recited values of about 1% to about 5%, but also include individual values and sub-ranges within the indicated range. Thus, included in this numerical range are individual values such as 2, 3. And 4 and sub-ranges such as from 1-3, from 2-4, and from 3-5, etc. This same principle applies to ranges reciting only one numerical value.

### Description of Embodiments

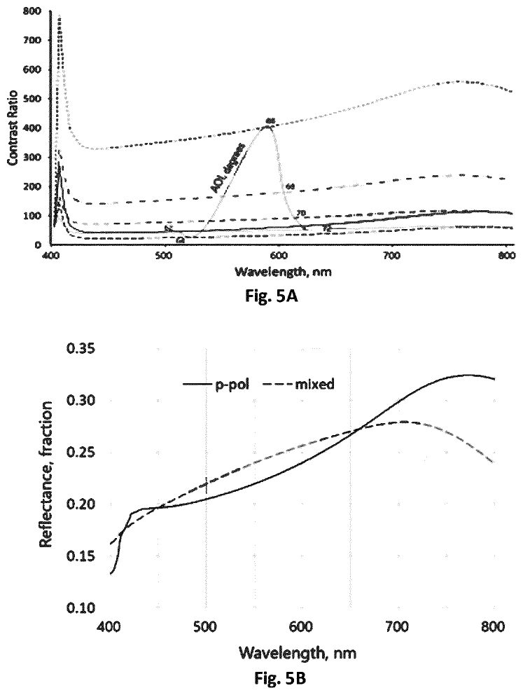

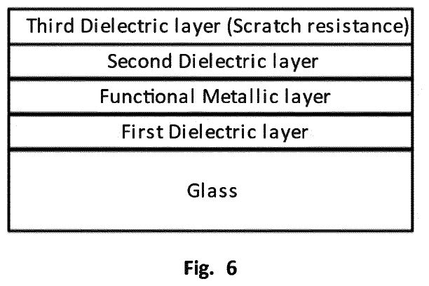

1. Embodiment one comprises a laminated automotive windshield with a 2.1 mm thick ultra-clear soda-lime inner and outer glass layer with a 0.76 mm thick PVB interlayer and a transparent HUD coating applied to the innermost surface (surface 4) of the inner glass pane. The HUD coating comprises (starting from the glass surface): a 54.3 nm thick SiNx layer, a 4.1 nm thick Al layer, a 43 nm thick SiOxNy layer, and a 39.5 nm thick encapsulating SiOx layer. The windshield is mounted in a vehicle equipped with a hud projector, mounted in the instrument panel, that projects a substantially p-polarized image incident to the windshield at angles between 6° and 73°. The HUD coating is applied to the entire area of surface four.
   FIG. 5A shows results of a simulation of the HUD coating of embodiment 1.
   The spectral distribution of the Contrast Ratio between the primary (surface 4) and secondary (surface 1) reflection for projected light with 100% p-polarization and various angles of incidence are depicted at FIG. 5A.
   The spectral distributions of the p-polarized and mixed-polarization reflectance in the visible part of the spectrum are presented in FIG. 5B.
2. Embodiment two is identical to the automotive laminate of embodiment one, except that the functional metallic layer comprises a 1.1 nm thick NiCr layer and 2.9 nm thick Al layer, wherein the percentage of Ni in the NiCr alloy is 55 wt. %.
3. Embodiment three is identical to the automotive laminate of embodiment one, except that the functional metallic layer comprises CrSi, wherein the percentage of Cr in the alloy is 95 wt. %.
4. Embodiment four is identical to the automotive laminate of embodiment one, except that the functional metallic layer comprises NiCrOx, wherein the percentage of Ni is 55% and the content of oxygen is 10%.
5. Embodiment five is identical to the automotive laminate of embodiment one, except that the functional metallic layer comprises AlAg, wherein the percentage of Al in the alloy is 5 wt. %.
6. Embodiment six is identical to the automotive laminate of embodiment one, except that the functional metallic layer comprises PtAg, wherein the percentage of Al in the alloy is 5 wt. %.
7. Embodiment seven is identical to the automotive laminate of embodiment one, except that the functional metallic layer comprises a NiCr, 4.5 nm thick, wherein the percentage of Ni in the alloy is 55 wt. %.
8. Embodiment eight uses the layer sequence of any of the embodiments 1-7. However, said coating is removed during processing from all the surface four except for an area defined as the driver field of view. This defined area is located at the bottom of the driver field of view. From the rest of surface four, the coating is removed by the following process:
   A special paint is applied by screen printing on surface four of the lamination in the area from which the coating is to be removed after bending.
   The coating is applied over the paint.
   The windshield is then subjected to high temperature bending.
   After bending the windshield is washed.
   Washing removes the paint and the coating applied over the paint.
   O The coating remains only in the defined area.
   The image is projected primarily on the defined area with the coating. The area is substantially transparent and extends above the obscuration area at the bottom of the windshield.
9. Embodiment nine is identical to the automotive laminate of embodiments 1-7, except that the black paint is applied on surface two of the laminate and extends inboard from the edge of glass beyond the typical periphery obscuration area used to hide the adhesive used to bond the glazing to the vehicle flange. The extended obscuration is used as at least a portion of the projection area.
10. Embodiment ten is identical to the automotive laminate of embodiment 8. The special paint is replaced by a mask that covers that portion of the glazing where the coating is not required and thus prevents the coating from being deposited onto the glass.
11. Embodiment eleven is identical to the automotive laminate of embodiment 8. However, the laminate is mounted in a vehicle with a HUD projector mounted in the instrument panel and projects an 80% p-polarized image.
12. Embodiment twelve comprises a tempered automotive sidelite with a transparent HUD coating applied to the innermost surface (surface 2) of the glass. The glass used is a dark grey soda-lime solar composition with 20% visible light transmission. The HUD coating comprises (starting from the glass surface): a 54.3 nm thick SiNx layer, a 4.1 nm thick Al layer, a 43 nm thick SiOxNy layer, and a 39.5 thick encapsulating SiOx layer. The coating is applied to the entire surface. A HUD projector is mounted in the roof and projects a primarily p-polarized image incident to the sidelite at angles between 6° and 73°.
13. Embodiment thirteen is identical to embodiments eight and nine with addition of a silver inclusive solar control coating applied to surface two 102. The solar control coating is not applied to an area corresponding to the area on surface four 104 where the HUD coating is applied. The edges of the two coated areas overlap by 3-6 mm.
14. Embodiment fourteen is identical to the automotive laminate of embodiment one, except that the scratch resistant third dielectric is comprised of diamond like carbon.
15. Embodiment fifteen is identical to the automotive laminate of embodiment one, except that the scratch resistant third dielectric is comprised of ZrOx.
16. Embodiment sixteen is identical to the automotive laminate of embodiment one, except that the scratch resistant third dielectric is comprised of ZrSiOx.
17. Embodiment seventeen is similar to any of the prior embodiments excluding Silver from the metallic interlayers of the functional metallic layer.

1. A vehicle glazing, comprising:
at least one glass layer having a surface to be positioned facing and adjacent to the interior of a vehicle; and
a transparent HUD coating deposited on at least a portion of said surface; wherein said HUD coating comprises starting from the glass surface:
at least one first dielectric layer, said first layer being a Si-based layer;
a functional metallic layer comprising at least one metallic sublayer, each formed by one or more metal elements from the group consisting of metal, alloy, combination of metal and alloy, wherein the total content of said one or more metal elements within each sublayer is at least 5 wt. % and wherein the concentration of oxygen or nitrogen in each metallic sublayer is less than or equal to 10%;
at least one second dielectric layer with an index of refraction between 1.4 and 2.0; and
at least one third dielectric layer having scratch resistance properties.

2. The glazing of claim 1, wherein said glazing has a total visible light transmission of at least 70%.

3. The glazing of claim 1 wherein when an image is projected by a p-polarization HUD projector, onto said at least a portion of the glass surface with the HUD coating, at an angle of incidence relative to the glass surface of between 60 and 73 degrees, an image comprising a primary and a secondary image is reflected with an optical characterization of:
a p-polarization reflection of at least 15% between 490 and 700 nm;
a contrast ratio between the primary and secondary image of at least 4:1; and
a mixed-polarization reflection between 490 and 700 nm of less than or equal to 40%.

4. The glazing of claim 1 wherein when an image is projected by a substantially p-polarization HUD projector, onto said at least a portion of the glass surface with the HUD coating, at an angle of incidence relative to the glass surface of between 60 and 73 degrees, an image comprising a primary and a secondary image is reflected with an optical characterization of:
a p-polarization reflection of at least 20% between 490 and 700 nm;
a contrast ratio between the primary and secondary image of at least 5:1; and
a mixed-polarization reflection between 490 and 700 nm of less than or equal to 30%.

5. The glazing of claim 1 wherein the functional metallic layer of the HUD coating has a thickness between 1 and 30 nm,
and/or wherein the second and third dielectric layers of the HUD coating have a combined thickness of at least 10 nm.

6. The glazing of claim 1 wherein said at least one metallic sublayer of the HUD coating is an alloy of one or more of the elements selected from the group consisting of Al, Ti, Ni, Cr, Pd, Pt, Cu, Co and Au with any other element, wherein the content of said one or more of the elements is at least 5 wt.

7. The glazing of claim 1, which meets at least one of the following conditions (i) to (iii):
(i) the first dielectric layer of the HUD coating is SiNx or SiOxNy;
(ii) the second dielectric of the HUD coating is ZnSnOx or SiOxNy; and/or
(iii) the third dielectric layer of the HUD coating is selected from the group consisting of:
ZrZnOx, ZrTiOx, ZrTiOxNy, TiOxNy, SiOx, ZrSiOx, ZrOx, and diamond-like carbon.

8. The glazing of claim 1 further comprising an obscuration; wherein the HUD coating overlaps at least partially the obscuration of the glazing and the projected image is at least partially projected onto said obscuration.

9. The glazing of claim 1 further comprising a solar-control coating, wherein the glazing is a laminate having at least two glass layers, wherein the solar-control coating is deposited on a surface of said at least two glass layers facing the interior of the laminate, and wherein said solar-control coating is not present in the area defined by the HUD coating, such that the two coatings do not substantially overlap.

10. The glazing of claim 1 wherein the HUD coating is deposited on substantially the entire surface of the glass layer.

11. The glazing of claim 1 which is selected from the group consisting of a windshield, a backlite, or a sidelite.

12. A HUD system comprising the vehicle glazing of claim 1 and further comprising a HUD projector that projects a p-polarized image onto at least a portion of the glass surface coated with the HUD coating.

13. The HUD system of claim 12 wherein the angle between the projected image of said HUD projector and the glazing is substantially at the Brewster angle of a glass/air interface within ±20%.

14. A vehicle comprising:
glazing of claim 1.

15. The vehicle of claim 14, wherein the vehicle further comprises a HUD system, which comprises the glazing and a HUD projector that projects a p-polarized image onto at least a portion of the glass surface coated with the HUD coating

16. The glazing of claim 1, wherein the metal elements comprise at least one or more metals from Al, Ti, Ni, Cr, Pd, Pt, Cu, Co and Au.

17. The glazing of claim 5, wherein the functional metallic layer of the HUD coating has a thickness between 1 and 15 nm;
and/or wherein the second and third dielectric layers of the HUD coating have a combined thickness between 10 nm and 220 nm.

18. The glazing of claim 1 wherein said at least one metallic sublayer of the HUD coating is an alloy of one or more of the elements selected from the group consisting of Al, Ti, Ni, Cr, Pd, Pt, Cu, Co and Au with any other element, wherein the content of said one or more of the elements is at least 10 wt. %.
